(19) United States
(12) Patent Application Publication
(10) Pub. No.: US 2026/0209963 A1
(43) Pub. Date: Jul. 23, 2026

(54) ELECTRIC CONTACTING ASSEMBLY FOR AN ELECTROCHEMICAL CELL UNIT

(71) Applicant: Robert Bosch GmbH, Stuttgart (DE)

(72) Inventors: Susanne Spindler, Stuttgart (DE); Arnold Gente, Stuttgart (DE); Patrick Nick, Ludwigsburg (DE)

(21) Appl. No.: 19/138,229

(22) PCT Filed: Dec. 12, 2023
(86) PCT No.: PCT/EP2023/085267

§ 371 Date: Jun. 12, 2025

(30) Foreign Application Priority Data
Dec. 12, 2022 (DE) 10 2022 213 454.0

(51) Int. Cl. C25B 9/65; C25B 1/04; C25B 15/06

(52) U.S. Cl. CPC C25B 9/65; C25B 15/06; C25B 1/04

(57) ABSTRACT

Electric contacting assembly for an electrochemical cell unit (20), comprising a housing (1) which has a plurality of slot-shaped recesses (7), each of which is designed to receive a contacting lug (22) of the electrochemical cell unit (20), wherein the housing (1) has a closed face (2). Each recess (7) is connected to the closed face (2) by a first bore (10) and a second bore (11). A contacting element (15) is arranged in each recess (7), which contacting element has a first pin (16), a second pin (17) and a contacting section (18), wherein each of the pins (16; 17) is arranged in one of the bores (10; 11) and the contacting section (18) protrudes into the recess (7) so that a contacting lug (22) can be clamped between the contacting section (18) and the wall of the recess (7) in an electrically contacting manner.

### BACKGROUND

The invention relates to an electric contacting assembly for an electrochemical cell unit, as used to contact a plurality of electrochemical cell units and preferably to connect them to a cell monitoring unit.

An electrochemical cell unit is, for example, a fuel cell and is used to generate electrical energy from chemical energy. Another well-known electrochemical cell unit is a so-called electrolyzer, which can be used to generate chemical energy—in particular hydrogen—from water and electricity. The electrochemical cell unit usually comprises a plurality of electrochemical cells connected in series in order to provide as much power per volume as possible. The individual electrochemical cells are separated by bipolar plates, at which the electrical voltage can be tapped at the individual cell and which also form the necessary channels for supplying and removing the chemical substances and the cooling medium. Since all electrochemical cells in a cell unit are connected in series during operation, it is important that all cells function properly. In fuel cells, this can be determined in particular by the electrical voltage generated, which is approximately 0.8-1.0 volts for each individual cell and should remain approximately constant during operation of the electrochemical cell unit. If a single electrochemical cell deviates significantly from this, this indicates a malfunction. This malfunction must be rectified at an early stage, as otherwise the entire electrochemical cell unit may fail.

Cell voltage monitoring (CVM) is used to monitor the voltage generated by the individual electrochemical cells. Such a cell monitoring unit is known, for example, from patent application DE 10 2020 204 292 A1. This monitoring unit usually contacts each individual bipolar plate and thus allows the electrical voltage at each individual cell to be measured. If the CVM registers a voltage deviation on a cell, an error is output and appropriate measures can be initiated. As a rule, the electrochemical cell unit must be switched off as quickly as possible in the event of a malfunction, otherwise there is a risk of irreparable damage. Since the individual electrochemical cells are relatively flat—usually only 1 to 2 mm—and are stacked on top of each other in large stacks of 100 to 500 cells, contacting each individual electrochemical cell or bipolar plate is relatively difficult and time-consuming, which is a significant cost factor in the manufacture of the electrochemical cell unit.

### SUMMARY

The electric contacting assembly for an electrochemical cell unit according to the invention has the advantage that simple and inexpensive contacting of each individual bipolar plate is possible. For this purpose, the electric contacting assembly has a housing which has a plurality of slot-shaped recesses, each of which is designed to receive a contacting lug, wherein the contacting lug is connected to a bipolar plate or is formed integrally with the bipolar plate. The housing has a closed face, wherein each recess is connected to the closed face by a first bore and a second bore. A contacting element is arranged in the recess, which has a first pin, a second pin and a contacting section, wherein the pins are arranged in one of the bores and the contacting section protrudes into the recess. The contacting section is designed such that a contacting lug can be clamped between the contacting section and the wall of the recess in an electrically contacting manner.

The electrochemical cell unit has a plurality of electrochemical cells stacked on top of each other. The electrochemical cells are formed by bipolar plates which delimit two adjacent electrochemical cells and in which the electrical connections are made. The electrical connections are led outwards in the form of contacting lugs, wherein the contacting lugs are formed integrally with the bipolar plate or by a separate component connected to the bipolar plate. The contacting lugs can be easily inserted into the slot-shaped recesses of the housing of the electric contacting assembly. The bipolar plate is contacted by the contacting section of the contacting element located within each recess when it is inserted into the housing. This electric junction is led by the contacting element to the closed face of the housing, where it can be connected to a corresponding evaluation unit. This simple electrical contact unit is inexpensive to manufacture and is suitable for contacting a large number of electrochemical cells and connecting them to an electrical cell monitoring unit.

In a first advantageous embodiment, the slot-shaped recesses are aligned parallel to each other so that a comb-shaped support structure is formed. In particular, the housing can be essentially cuboid in shape and, in addition to the closed face, have an opposing open face and two lateral surfaces, wherein the lateral surfaces connect the closed face and the open face. This results in recesses that are open on three sides, so that the contacting lugs can be easily inserted. Such comb-shaped support structures can be produced, for example, by sawing a block, wherein the block and thus the housing are made of an electrically non-conductive material, for example plastic or ceramic.

The first pin of the contacting element is advantageously arranged in the assembly position in a bore and protrudes from the closed face of the housing, while the second pin does not protrude beyond the closed face. Since the first pin is in electrical contact with the contacting section of the contacting element, an electrical connection is established between the pin protruding beyond the housing and in the\ contacting lug or bipolar plate. The second pin, which is also received in a bore, prevents the contacting element from slipping or rotating within the recess and thereby interrupting the contact.

In a further advantageous embodiment, the thickness of the contacting section of the contacting element in a stacking direction of the electric contacting assembly or of the housing is smaller than the thickness of the recess. This provides space for receiving the contacting lug and for clamping the contacting lug between the contacting section of the contacting element and the wall of the recess.

In a further advantageous embodiment, the first bores, which each connect a recess to the closed face of the housing, are arranged in a row, wherein this row extends in a stacking direction of the housing, which also corresponds to the stacking direction of the electrochemical cell when the electric contacting assembly is mounted on the electrochemical cell unit. The second bores are also advantageously arranged in a row and likewise one above the other in the stacking direction.

In a further advantageous embodiment, the contacting elements are arranged in the recesses in such a way that the first contacting pins protrude alternately from the first bores and the second bores, so that in adjacent recesses the first contacting pins protrude alternately from the first bore and the second bore. This results in a relatively large distance between the contacting pins, which can then be more easily connected to an electrical evaluation unit.

### BRIEF DESCRIPTION OF THE DRAWINGS

The drawing shows various exemplary embodiments of the electric contacting assembly. The following are shown:

FIG. 1 a perspective view of an electric contacting assembly or of the housing of the electric contacting assembly, wherein, for the sake of clarity, only a small part of the electric contacting assembly is shown,

FIG. 2a shows the electric contacting element,

FIG. 2b the same electric contacting element in a different orientation,

FIG. 3a the installation position of the contacting element within the housing,

FIG. 3b the installation position of the contacting element in an adjacent recess of the housing

FIG. 4 a cross-section through the housing showing the contacting of the contacting lug, and

FIG. 5 the electric contacting assembly with mounted contacting elements in a perspective view.

### DETAILED DESCRIPTION

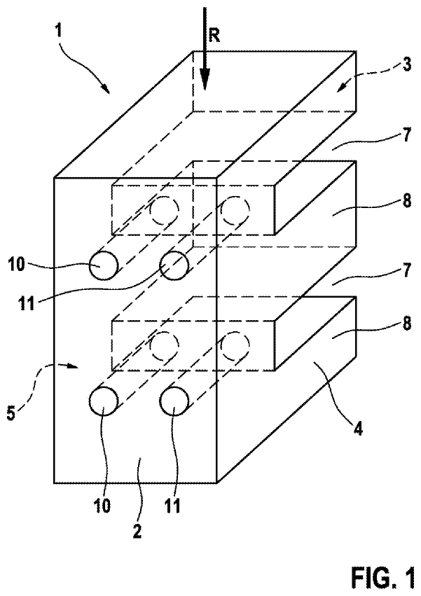

FIG. 1 shows a perspective view of an electric contacting assembly according to the invention, wherein only the housing is shown. The housing 1 is of a cuboid shape and has a closed face 2 opposite an open face 3. Both sides 2, 3 are connected to each other by lateral surfaces 4 and 5. The housing 1 has a plurality of slot-shaped recesses 7 which are open towards the open faces 3 and towards the lateral surfaces 4 and 5 and are parallel to each other. This creates a comb-shaped structure of the housing 1 with recesses 7 that are open on three faces of the rectangular housing 1. The recesses 7 are each connected to the closed face 2 of the housing 1 via a first bore 10 and a second bore 11 parallel to this. The bores 10, 11 form first openings 110 and second openings 111 on the closed face 2. All first bores 10 and second bores 11 are arranged in a row one above the other in the stacking direction R, so that all first openings 110 and second openings 111 also form a row. For clarity, the housing 1 shown in FIG. 1 shows only two recesses 7. In real applications, there are usually significantly more recesses 7, possibly several hundred depending on the number of contacts of the electrochemical cell unit.

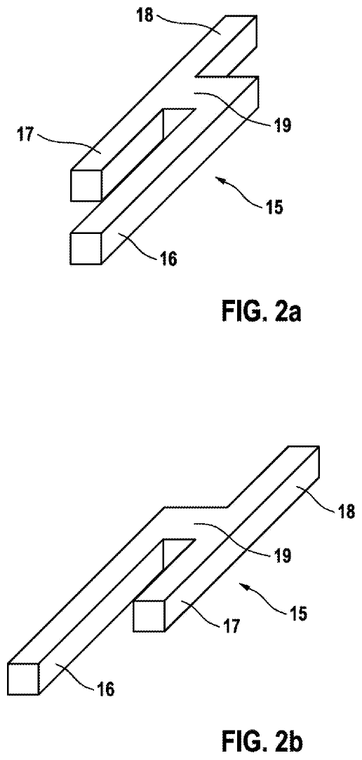

FIG. 2a, shows a contacting element 15 as intended for mounting in a recess 7. The contacting element 15 has a first pin 16 and a second pin 17 which are parallel to each other, wherein the first pin 16 is longer than the second pin 17. Both pins 16, 17 are connected to each other via a connecting section 19. A contacting section 18 is also connected to the connecting section 19, which is opposite the second pin 17, so that the contacting element 15 essentially has the shape of an h. FIG. 2b shows the same contacting element 15, but rotated 180 degrees, which corresponds to the installation position in an adjacent recess 7 of the housing 1. In FIGS. 2a and 2b, the pins 15, 16 have a square cross-section; however, a contacting element 15 with a differently shaped cross-section, for example round, oval or rectangular, can also be used.

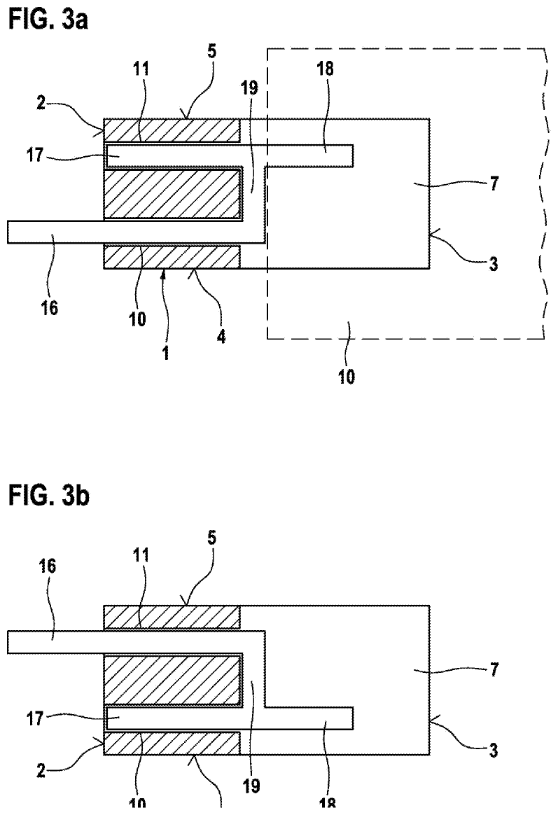

FIG. 3a shows a cross-section of the installation position of the contacting element 15 in the housing 1 or in a recess 7. The first pin 16 is arranged in the first bore 10 and the second pin 17 in the second bore 11, wherein the first pin 16 protrudes beyond the closed face 2 of the housing 1 due to its length, where it can be electrically contacted and connected to a voltage monitoring unit. The contacting section 18 protrudes into the recess 7, but not beyond the open face 3 of the housing 1. On the right-hand side of FIG. 3a, a contacting lug 22 is shown which is electrically connected to a bipolar plate or is part of a bipolar plate. The bipolar plate is part of an electrochemical cell unit, such as a fuel cell or an electrolyzer. The contacting lug protrudes into the recess 7 and is in contact with the contacting section 18 of the contacting element 15 and thus electrically connected to it. This establishes an electrical connection between the first pin 16 of the contacting element 15 protruding beyond the closed face 2 of the housing 1 and the bipolar plate. FIG. 3b shows the same arrangement as FIG. 3a, but with the contact element installed in an adjacent recess 7 of the housing 1. Here, the contacting element has been rotated through 180 degrees in the plane so that the first pin 16 now protrudes through the second bore 11 and the second pin 17 protrudes through the first bore 10 of this recess 7.

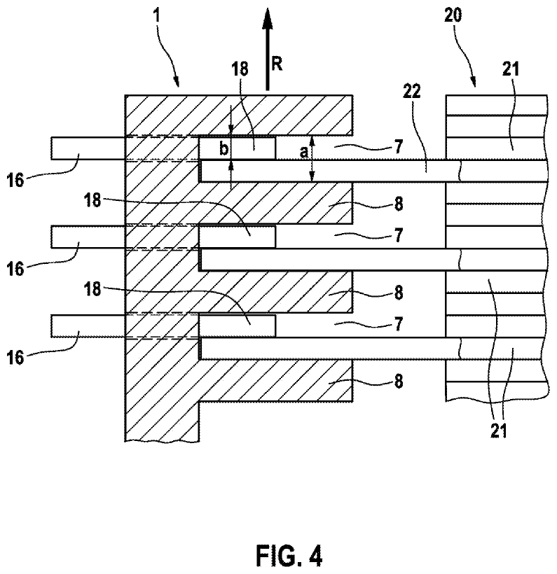

FIG. 4 shows the contacting of an electrochemical cell unit 20 by the electric contacting assembly in a longitudinal section through the housing 1. The electrochemical cell unit 20 has a plurality of electrochemical cells 21 stacked one above the other, wherein the individual electrochemical cells 21 are formed by bipolar plates. Each bipolar plate delimits two adjacent electrochemical cells 21 and also forms an electrical contact of the associated electrochemical cell. The electrical junction of the bipolar plate can be led outwards in the form of a contacting lug 22, which protrudes beyond the edge of the electrochemical cell unit 20 and projects into a recess 7 of the housing 1. The contacting lug 22 can be part of the bipolar plate or connected to the bipolar plate as a separate component. Since the slot-shaped recess 7 has a thickness a in the stacking direction which is greater than the thickness b of the contacting section 18, the contacting lug 22 can be clamped between the contacting section 18 and the wall of the recess 7 and thus be electrically connected to the contacting element 15.

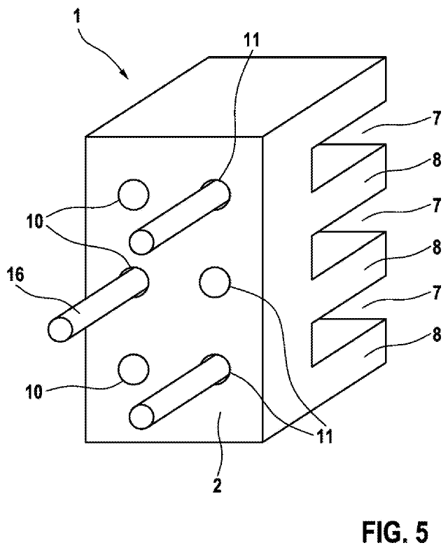

To assemble the electric contacting assembly, the housing 1 is provided with the contacting elements 15, which are installed in alternating orientations, as shown in FIG. 2a and FIG. 2b. The first pins 16 protrude alternately through the first bore 10 and the second bore 11 of the recesses 7 so that they protrude beyond the closed face 2 of the housing 1 as shown in FIG. 5. The alternating orientation of the contacting elements 15 increases the distance between the adjacent first pins 16, which facilitates contacting with an electrical evaluation unit. It should be noted that an electrochemical cell unit often comprises several hundred electrochemical cells, which are only approx. 1 mm thick. The distance between the first pins 16 is correspondingly small. The electric contacting assembly is then brought into contact with an electrochemical cell unit so that a contacting lug 22 slides into a recess 7 and is clamped there between the contacting section 18 of the respective contacting element 15 and the wall of the recess 7, thereby making electrical contact.

The contacting element 15 preferably consists of a metallic wire with good electrical conductivity. The wire can have a round, square or rectangular cross-section, as shown in FIG. 2a and FIG. 2b by way of example. However, other cross-sections can also be used, for example oval, in order to improve the clamping of the contacting lug 22. In any case, the dimensions of pins 16, 17 must be matched to the bores 10, 11 so that pins 16, 17 can be inserted into bores 10, 11. Accordingly, the bores 10, 11 can also be manufactured with a square, rectangular or oval cross-section, for example.

1. An electric contacting assembly for an electrochemical cell unit (20), comprising a housing (1) which has a plurality of slot-shaped recesses (7), each of which is configured to receive a contacting lug (22), wherein the housing (1) has a closed face (2), wherein each recess (7) is connected to the closed face (2) by a first bore (10) and a second bore (11) and a contacting element (15) is arranged in the recess (7), which contacting element has a first pin (16), a second pin (17) and a contacting section (18), wherein each of the pins (16; 17) is arranged in one of the bores (10; 11) and the contacting section (18) protrudes into the recess (7) so that the contacting lug (22) can be clamped between the contacting section (18) and a wall of the recess (7) to establish an electrical connection between the contacting element (15) and the contacting lug (22).

2. The electric contacting assembly according to claim 1, wherein the slot-shaped recesses (7) are aligned parallel to each other so that a comb-shaped support structure is formed.

3. The electric contacting assembly according to claim 2, wherein the housing (1) is essentially cuboid in shape and has an open face (3) opposite the closed face (2), a first lateral surface (4) and a second lateral surface (5), wherein the lateral surfaces (4; 5) connect the closed face (2) and the open face (3).

4. The electric contacting assembly according to claim 3, wherein the recesses (7) are open toward the open face (3) and toward the lateral surfaces (4; 5).

5. The electric contacting assembly according to claim 1, wherein the first pin (16) of the contacting element (15) protrudes from the closed face (2) of the housing (1) in the assembly position and the second pin (17) does not protrude beyond the closed face (2).

6. The electric contacting assembly according to claim 5, wherein the first pin (16) is electrically connected to the contacting section (18).

7. The electric contacting assembly according to claim 1, wherein a thickness (b) of the contacting section (18) of the contacting element (15) in a stacking direction (R) of the slot-shaped recess (7) is smaller than a thickness (a) of the recess (7).

8. The electric contacting assembly according to claim 1, wherein the first bores (10) and the second bores (11) on the closed face (2) of the housing (1) each form an opening (110; 111) and the openings (110; 111) of the first bores (10) and of the second bores (11) are each arranged one above the other in a stacking direction (R).

9. The electric contacting assembly according to claim 8, wherein the first contacting pins (16) of the contacting elements (15) at adjacent recesses (7) protrude alternately from the first bores (10) and second bores (11).
